(19) United States
(12) Patent Application Publication
(10) Pub. No.: US 2018/0291204 A1
(43) Pub. Date: Oct. 11, 2018

(54) IMPROVED DIELECTRIC STRENGTH COMPOSITIONS

(71) Applicant: SABIC Global Technologies B.V., Bergen op Zoom (NL)

(72) Inventor: Kapil Chandrakant SHETH, Evansville, IN (US)

(21) Appl. No.: 15/573,937

(22) PCT Filed: May 10, 2016
(86) PCT No.: PCT/US2016/031576

§ 371 Date: Nov. 14, 2017

Related U.S. Application Data
(60) Provisional application No. 62/163,120, filed on May 18, 2015.

(51) Int. Cl. C08L 79/08; B29C 45/00

(52) U.S. Cl. CPC C08L 79/08; B29K 2079/085; C08L 2207/062; B29C 45/0001

(57) ABSTRACT

A molded article having improved dielectric strength is disclosed. The molded article is formed by (a) providing a thermoplastic resin composition including a base polymer resin and a mold release agent; and (b) molding the thermoplastic resin composition to form the molded article. The dielectric strength of the molded article formed is higher than a comparator molded article comprising the thermoplastic resin composition in the absence of the mold release agent.

### CROSS REFERENCE TO RELATED APPLICATION

This application claims the benefit of U.S. Provisional Application No. 62/163,120, filed May 18, 2015, the entirety of which is incorporated by reference herein.

### TECHNICAL FIELD

The disclosure generally relates to articles having improved properties for use in electrical and electronic components, and more particularly to molded articles having improved dielectric strength and to a process for the production thereof.

### BACKGROUND

Thermoplastic resins are used extensively in the electrical and the electronics industry to form a broad array of different components such as wire coatings, junctions, and pottings. Typically, these electrical components must be tough, flexible products that have superior electrical insulating properties. Therefore, these components must have high dielectric strengths (also known as breakdown voltages), but still possess the desired mechanical properties.

High dielectric strengths are often achieved in molded articles by using large volume fractions of fillers in the thermoplastic resins used to produce them. This, however, usually reduces the desired mechanical properties such as impact strength and ductility in the molded article. Furthermore, electrical components are quickly getting miniaturized. Providing equivalent electrical insulation capability in a thinner part also requires materials with improved dielectric strength. Therefore, there is a need for thermoplastic resin compositions that can produce molded articles having a high dielectric strength as well as good mechanical strength and processability.

Accordingly, the present disclosure provides such thermoplastic resins and molded articles formed thereof that have improved dielectric strength and mechanical strength over currently existing articles. A process for producing these molded articles having improved dielectric strength is also described herein.

### SUMMARY

In accordance with one aspect of the disclosure, a process for the production of a molded article is disclosed. The process includes (a) providing a thermoplastic resin composition including a base polymer resin and a mold release agent, and (b) molding the thermoplastic resin composition to form the molded article. The dielectric strength of the molded article formed is higher than a comparator molded article comprising the thermoplastic resin composition in the absence of the mold release agent.

In accordance with another aspect of the disclosure, a molded article having improved dielectric strength is disclosed. The molded article is formed by (a) providing a thermoplastic resin composition including a base polymer resin and a mold release agent; and (b) molding the thermoplastic resin composition to form the molded article. The dielectric strength of the molded article formed is higher than a comparator molded article comprising the thermoplastic resin composition in the absence of the mold release agent.

### DETAILED DESCRIPTION

In certain aspects of the present disclosure, molded articles having improved dielectric strength are disclosed. The molded articles are formed using a thermoplastic resin composition. In one aspect of the present disclosure, the thermoplastic resin composition may include a base polymer resin and a mold release agent. Other components, however, may also be included in the thermoplastic resin composition. Generally, the thermoplastic resin composition is suitable for melt processing such that the molded article may be formed using a melt process and in particular, injection molding.

### Base Polymer Resin

In certain aspects of the present disclosure, the thermoplastic resin composition includes a base polymer resin. The base polymer resin may be any polymeric material known in the art. The selection of the base polymer resin may depend on the desired properties and the application for the molded article formed therefrom. The base polymer resin may be composed of more than one base polymer resin.

In one aspect of the disclosure, the base polymer resin used in the thermoplastic resin composition may be selected from a wide variety of thermoplastic polymers, and blends of thermoplastic polymers. The base polymer resin can comprise a homopolymer, a copolymer such as a star block copolymer, a graft copolymer, an alternating block copolymer or a random copolymer, ionomer, dendrimer, or a combination comprising at least one of the foregoing. The base polymer resin may also be a blend of polymers, copolymers, terpolymers, or the like, or a combination comprising at least one of the foregoing.

Examples of thermoplastic polymers that can be used as the base polymer resin include polyacetals, polyacrylics, polycarbonates, polyalkyds, polystyrenes, polyolefins, polyesters, polyamides, polyaramides, polyamideimides, polyarylates, polyurethanes, epoxies, phenolics, silicones, polyarylsulfones, polyethersulfones, polyphenylene sulfides, polysulfones, polyimides, polyetherimides, polytetrafluoroethylenes, polyetherketones, polyether etherketones, polyether ketone ketones, polybenzoxazoles, polyoxadiazoles, polybenzothiazinophenothiazines, polybenzothiazoles, polypyrazinoquinoxalines, polypyromellitimides, polyquinoxalines, polybenzimidazoles, polyoxindoles, polyoxoisoindolines, polydioxoisoindolines, polytriazines, polypyridazines, polypiperazines, polypyridines, polypiperidines, polytriazoles, polypyrazoles, polycarboranes, polyoxabicyclononanes, polydibenzofurans, polyphthalides, polyacetals, polyanhydrides, polyvinyl ethers, polyvinyl thioethers, polyvinyl alcohols, polyvinyl ketones, polyvinyl halides, polyvinyl nitriles, polyvinyl esters, polysulfonates, polysulfides, polythioesters, polysulfones, polysulfonamides, polyureas, polyphosphazenes, polysilazanes, polypropylenes, polyethylenes, polyethylene terephthalates, polyvinylidene fluorides, polysiloxanes, or the like, or a combination comprising at least one of the foregoing thermoplastic polymers.

Examples of blends of thermoplastic polymers that can be used as the base polymer resin include acrylonitrile-butadiene-styrene/nylon, polycarbonate/acrylonitrile-butadiene-styrene, polyphenylene ether/polystyrene, polyphenylene ether/polyamide, polycarbonate/polyester, polyphenylene ether/polyolefin, or the like, or a combination comprising at least one of the foregoing.

In one aspect of the present disclosure, the base polymer resin may include, polycarbonates, polysulfones, polyesters, polyamides, polypropylene. In a further aspect, the polyimides used in the disclosed thermoplastic resin composition may include polyamideimides, polyetherimides and polybenzimidazoles. In a further aspect, polyetherimides comprise melt processable polyetherimides.

In one aspect of the disclosure, the base polymer resin is present in the thermoplastic resin composition in an amount of at least 85 weight % of the total weight of the thermoplastic resin composition. In a further aspect, the base polymer resin is at least 90 weight %, of the total weight of the thermoplastic resin composition. In still a further aspect, the base polymer resin is at least 95 weight %, of the total weight of the thermoplastic resin composition. In still a further aspect, the base polymer resin is at least 96 weight %, of the total weight of the thermoplastic resin composition. In still a further aspect, the base polymer resin is at least 97 weight %, of the total weight of the thermoplastic resin composition. In still a further aspect, the base polymer resin is at least 98 weight %, of the total weight of the thermoplastic resin composition. In a further aspect, the base polymer resin is at least 99 weight %, of the total weight of the thermoplastic resin composition.

### Polyetherimides

Suitable polyetherimides that can be used in the disclosed composition include, but are not limited to, ULTEM™. ULTEM™ is a polymer from the family of polyetherimides (PEI) sold by Saudi Basic Industries Corporation (SABIC). ULTEM™ can have elevated thermal resistance, high strength and stiffness, and broad chemical resistance. ULTEM™ as used herein refers to any or all ULTEM™ polymers included in the family unless otherwise specified. In a further aspect, the ULTEM™ is ULTEM™ 1000. In one aspect, a polyetherimide can comprise any polycarbonate material or mixture of materials, for example, as recited in U.S. Pat. No. 4,548,997; U.S. Pat. No. 4,629,759, U.S. Pat. No. 4,816,527; U.S. Pat. No. 6,310,145; and U.S. Pat. No. 7,230,066, all of which are hereby incorporated in its entirety for the specific purpose of disclosing various polyetherimide compositions and methods.

In certain aspects, the base polymer resin is a polyetherimide polymer having a structure comprising structural units represented by an organic radical of formula (I):

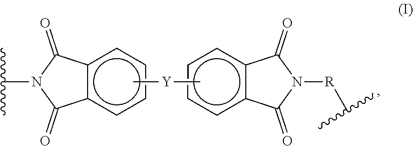

wherein R in formula (I) includes substituted or unsubstituted divalent organic radicals such as (a) aromatic hydrocarbon radicals having about 6 to about 20 carbon atoms and halogenated derivatives thereof; (b) straight or branched chain alkylene radicals having about 2 to about 20 carbon atoms; (c) cycloalkylene radicals having about 3 to about 20 carbon atoms, or (d) divalent radicals of the general formula (II):

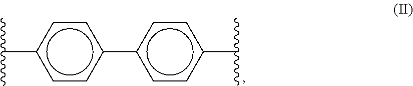

wherein Q includes a divalent moiety selected from the group consisting of —O—, —S—, —C(O)—, —SO2-, —SO—, -CyH2y- (y being an integer from 1 to 5), and halogenated derivatives thereof, including perfluoroalkylene groups; wherein T is —O— or a group of the formula —O—Z—O— wherein the divalent bonds of the —O— or the —O—Z—O— group are in the 3,3′, 3,4′, 4,3′, or the 4,4′ positions, and wherein Z includes, but is not limited, to divalent radicals of formula (III):

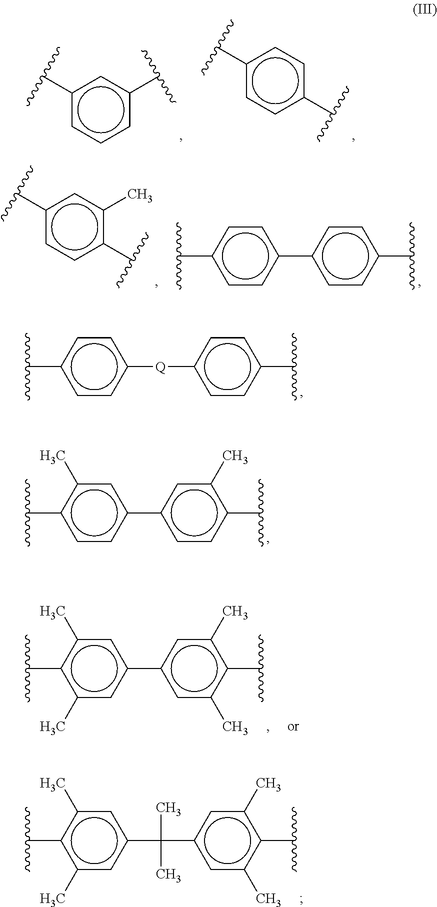

and wherein the polyetherimides which are included by formula (I) have a Mw of at least about 20,000.

In a further aspect, the polyetherimide polymer may be a copolymer, which, in addition to the etherimide units described above, further contains polyimide structural units of the formula (IV):

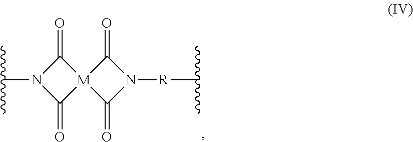

wherein R is as previously defined for formula (I) and M includes, but is not limited to, radicals of formula (V):

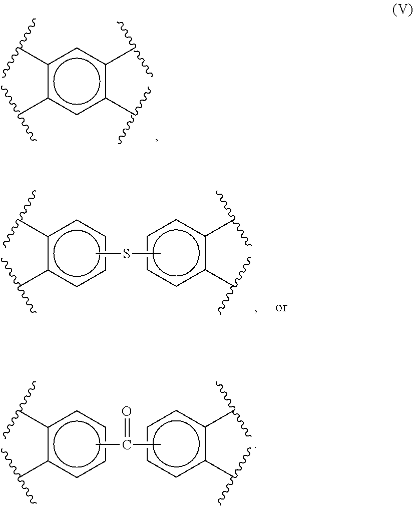

In a further aspect, the thermoplastic resin is a polyetherimide polymer having structure represented by a formula:

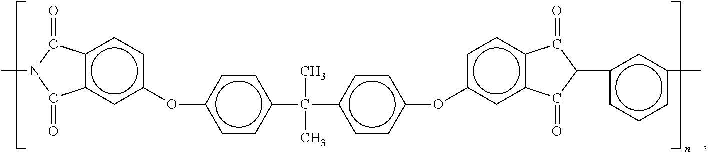

wherein the polyetherimide polymer has a molecular weight of at least 40,000 Daltons, 50,000 Daltons, 60,000 Daltons, 80,000 Daltons, or 100,000 Daltons.

The polyetherimide polymer can be prepared by methods known to one skilled in the art, including the reaction of an aromatic bis(ether anhydride) of the formula (VI):

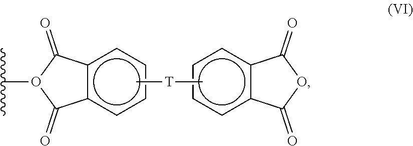

with an organic diamine of the formula (IX):

H₂N—R—NH₂ (VII),

wherein T and R are defined as described above in formula (I).

Illustrative, non-limiting examples of aromatic bis(ether anhydride)s of formula (VI) include 2,2-bis[4-(3,4-dicarboxyphenoxy)phenyl]propane dianhydride; 4,4′-bis(3,4-dicarboxyphenoxy)diphenyl ether dianhydride; 4,4′-bis(3,4-dicarboxyphenoxy)diphenyl sulfide dianhydride; 4,4′-bis(3,4-dicarboxyphenoxy)benzophenone dianhydride; 4,4′-bis(3,4-dicarboxyphenoxy)diphenyl sulfone dianhydride; 2,2-bis[4-(2,3-dicarboxyphenoxy)phenyl]propane dianhydride; 4,4′-bis(2,3-dicarboxyphenoxy)diphenyl ether dianhydride; 4,4′-bis(2,3-dicarboxyphenoxy)diphenyl sulfide dianhydride; 4,4′-bis(2,3-dicarboxyphenoxy)benzophenone dianhydride; 4,4′-bis(2,3-dicarboxyphenoxy)diphenyl sulfone dianhydride; 4-(2,3-dicarboxyphenoxy)-4′-(3,4-dicarboxyphenoxy)diphenyl-2,2-propane dianhydride; 4-(2,3-dicarboxyphenoxy)-4′-(3,4-dicarboxyphenoxy)diphenyl ether dianhydride; 4-(2,3-dicarboxyphenoxy)-4′-(3,4-dicarboxyphenoxy)diphenyl sulfide dianhydride; 4-(2,3-dicarboxyphenoxy)-4′-(3,4-dicarboxyphenoxy)benzophenone dianhydride and 4-(2,3-dicarboxyphenoxy)-4′-(3,4-dicarboxyphenoxy)diphenyl sulfone dianhydride, as well as various mixtures thereof.

The bis(ether anhydride)s can be prepared by the hydrolysis, followed by dehydration, of the reaction product of a nitro substituted phenyl dinitrile with a metal salt of dihydric phenol compound in the presence of a dipolar, aprotic solvent. A useful class of aromatic bis(ether anhydride)s included by formula (VI) above includes, but is not limited to, compounds wherein T is of the formula (VIII):

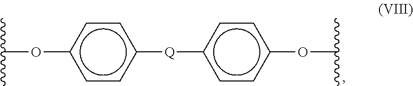

and the ether linkages, for example, are beneficially in the 3,3′, 3,4′, 4,3′, or 4,4′ positions, and mixtures thereof, and where Q is as defined above.

Any diamino compound may be employed in the preparation of the polyimides and/or polyetherimides. Illustrative, non-limiting examples of suitable diamino compounds of formula (VII) include ethylenediamine, propylenediamine, trimethylenediamine, diethylenetriamine, triethylenetertramine, hexamethylenediamine, heptamethylenediamine, octamethylenediamine, nonamethylenediamine, decamethylenediamine, 1,12-dodecane diamine, 1,18-octadecanediamine, 3-methylheptamethylenediamine, 4,4-dimethylheptamethylenediamine, 4-methylnonamethylenediamine, 5-methylnonamethylene diamine, 2,5-dimethylhexamethylenediamine, 2,5-dimethylheptamethylenediamine, 2,2-dimethylpropylenediamine, N-methyl-bis(3-aminopropyl)amine, 3-methoxyhexamethylene diamine, 1,2-bis(3-aminopropoxy) ethane, bis(3-aminopropyl) sulfide, 1,4-cyclohexane diamine, bis-(4-aminocyclohexyl) methane, m-phenylenediamine, p-phenylenediamine, 2,4-diaminotoluene, 2,6-diaminotoluene, m-xylylenediamine, p-xylylenediamine, 2-methyl-4,6-diethyl-1,3-phenylene-diamine, 5-methyl-4,6-diethyl-1,3-phenylene-diamine, benzidine, 3,3′-dimethylbenzidine, 3,3′-dimethoxybenzidine, 1,5-diaminonaphthalene, bis(4-aminophenyl) methane, bis(2-chloro-4-amino-3,5-diethyl phenyl) methane, bis(4-aminophenyl) propane, 2,4-bis(b-amino-t-butyl) toluene, bis(p-b-amino-t-butylphenyl)ether, bis(p-b-methyl-o-aminophenyl)benzene, bis(p-b-methyl-o-aminopentyl)benzene, 1,3-diamino-4-isopropyl benzene, bis(4-aminophenyl) sulfide, bis(4-aminophenyl) sulfone, bis(4-aminophenyl)ether and 1,3-bis(3-aminopropyl)tetramethyldisiloxane. Mixtures of these compounds may also be present. Beneficial diamino compounds are aromatic diamines, especially m- and p-phenylenediamine and mixtures thereof.

In a further aspect, the polyetherimide resin includes structural units according to formula (I) wherein each R is independently p-phenylene or m-phenylene or a mixture thereof and T is a divalent radical of the formula (IX):

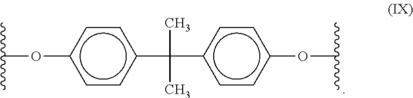

In various aspects, the reactions can be carried out employing solvents such as o-dichlorobenzene, m-cresol/toluene, or the like, to effect a reaction between the anhydride of formula (VI) and the diamine of formula (VII), at temperatures of about 100° C. to about 250° C. Alternatively, the polyetherimide can be prepared by melt polymerization of aromatic bis(ether anhydride)s of formula (VI) and diamines of formula (VII) by heating a mixture of the starting materials to elevated temperatures with concurrent stirring. Melt polymerizations can employ temperatures of about 200° C. to about 400° C. Chain stoppers and branching agents can also be employed in the reaction. The polyetherimide polymers can optionally be prepared from reaction of an aromatic bis(ether anhydride) with an organic diamine in which the diamine is present in the reaction mixture at no more than about 0.2 molar excess, and beneficially less than about 0.2 molar excess. Under such conditions the polyetherimide resin has less than about 15 microequivalents per gram (eq/g) acid titratable groups in one embodiment, and less than about 10 μeq/g acid titratable groups in an alternative embodiment, as shown by titration with chloroform solution with a solution of 33 weight percent (wt %) hydrobromic acid in glacial acetic acid. Acid-titratable groups are essentially due to amine end-groups in the polyetherimide resin.

In a further aspect, the polyetherimide resin has a weight average molecular weight (Mw) of at least about 20,000 to about 150,000 grams per mole (g/mole), as measured by gel permeation chromatography, using a polystyrene standard. In a still further aspect, the thermoplastic resin can have a molecular weight of at least 40,000 Daltons, 50,000 Daltons, 60,000 Daltons, 80,000 Daltons, or 100,000 Daltons. In a yet further aspect, the thermoplastic resin can have a molecular weight of at least 40,000 Daltons. In an even further aspect, the thermoplastic resin can have a molecular weight of at least 45,000 Daltons. In a still further aspect, the thermoplastic resin can have a molecular weight of at least 50,000 Daltons. In a yet further aspect, the thermoplastic resin can have a molecular weight of at least 60,000 Daltons. In an even further aspect, the thermoplastic resin can have a molecular weight of at least 70,000 Daltons. In a still further aspect, the thermoplastic resin can have a molecular weight of at least 100,000 Daltons.

In a further aspect, the thermoplastic resin can comprise a polyetherimide polymer having a molecular weight of at least 40,000 Daltons, 50,000 Daltons, 60,000 Daltons, 80,000 Daltons, or 100,000 Daltons. In a yet further aspect, polyetherimide polymer has a molecular weight of at least Daltons, 40,000 Daltons or 50,000 Daltons. In a still further aspect, the polyetherimide polymer has a molecular weight of at least 40,000 Daltons. In a yet further aspect, the polyetherimide polymer has a molecular weight of at least 50,000 Daltons. In an even further aspect, the polyetherimide polymer has a molecular weight of at least 60,000 Daltons. In a still further aspect, the polyetherimide polymer has a molecular weight of at least 70,000 Daltons. In yet a further aspect, the polyetherimide polymer has a molecular weight of at least 100,000 Daltons.

### Mold Release Agent

In certain aspects of the present disclosure, the thermoplastic resin composition also includes a mold release agent. A wide variety of mold release agents may be used in the thermoplastic resin. The thermoplastic resin may also include more than one mold release agent. Typically, the mold release agent selected should be chemically compatible with the base polymer resin and other components in the thermoplastic resin composition.

The mold release agent may be added to the thermoplastic resin in the normal manner that the other components are added, for example, in the dry or liquid stage and coextruded or in a solvent and melt extruded with the thermoplastic resin composition.

In a further aspect, the mold release agent is at least 1.0 weight percent of the total weight of the thermoplastic resin composition. In a still further aspect, the mold release agent is at least 2.0 weight percent of the total weight of the thermoplastic resin composition.

In a further aspect, the mold release agent is present in the thermoplastic resin composition from about 0.01 to about 3.0 weight percent of the total weight of the thermoplastic resin composition. In yet another aspect, the mold release agent is present in the thermoplastic resin composition from about 0.1 to about 0.4 weight percent of the total weight of the thermoplastic resin composition.

The mold release agent is generally added to the base polymer resin to reduce the composition's adherence to the mold during melt processing or injection molding operations. However, it has surprisingly been discovered that the dielectric strength of articles molded using a thermoplastic resin composition that includes a mold release agent is significantly higher than comparator molded articles comprising the same thermoplastic resin composition without the mold release agent. These higher dielectric strengths in molded articles comprising mold release agent are presented in the examples below.

Suitable mold release agents may include, for example phthalic acid esters such as dioctyl-4,5-epoxy-hexahydrophthalate; tristearin; poly-alpha-olefins; epoxidized soybean oil; silicones, including silicone oils; esters, for example, fatty acid esters such as alkyl stearyl esters, e.g., methyl stearate, stearyl stearate, pentaerythritol tetrastearate, and the like; combinations of methyl stearate and hydrophilic and hydrophobic nonionic surfactants comprising polyethylene glycol polymers, polypropylene glycol polymers, poly(ethylene glycol-co-propylene glycol) copolymers, or a combination comprising at least one of the foregoing glycol polymers, e.g., methyl stearate and polyethylene-polypropylene glycol copolymer in a suitable solvent; and waxes such as beeswax, paraffin wax, or the like. In one embodiment, the mold release agent is a salt or an ester of one or more long chain, aliphatic carboxylic acids having from 12 to 36 carbon atoms.

In a further aspect, the mold release agent may be selected from the group consisting of aliphatic polyesters, poly-alpha-olefins, aliphatic polyamides, carboxylic acid salts, and mixtures thereof. In yet a further aspect, the mold release agent may include silicone, polypropylene, polyphenylene ether or polyethylene. In a still further aspect, the mold release agent may be high density polyethylene.

Polyethylene

Polyethylenes are commercially available in a variety of molecular structures. The chemical and physical properties of these polymers depend largely upon the temperatures, pressures, catalyst types, modifiers, and reactor design used in the manufacture of polyethylene. For uses in the present disclosure, the polyethylene may be of the high density type (hereinafter referred to as HDPE). These resins generally have a nominal density of 0.95 g/cm³ or greater. High molecular weight high density polyethylene can also be used in the present invention. High molecular weight high density polyethylene is a name given to those high density polyethylene resins having a weight average molecular weight (Mw) between 300,000 and 500,000. Yet another high density polyethylene that may be used in the present disclosure is known as ultra-high molecular weight polyethylene. Generally these resins have a molecular weight in the range of 3 million to about 6 million.

### Other Components

In certain aspects of the present disclosure, reinforcing fillers may comprise an additional optional component of the thermoplastic resin composition. Reinforcing fillers, per se, are also well known in the art. Accordingly, virtually any reinforcing filler known in the art is suitable according to the present invention. For example, the present disclosure may include at least one inorganic filler selected from glass, asbestos, talc, quartz, calcium carbonate, calcium sulfate, barium sulfate, carbon fiber, silica, zinc oxide, zirconium oxide, zirconium silicate, strontium sulfate, alumina, anhydrous aluminum silicate, barium ferrite, mica, feldspar, clay, magnesium oxide, magnesium silicate, nepheline syenite, phenolic resins, wollastonite, and titanium dioxide or mixtures thereof. The term glass fillers in intended to include any type of glass used as a filler such as glass fibers, mill glass, glass spheres and microspheres, etc.

In a further aspect, the thermoplastic resin composition may include carbon black. In a still further aspect, the thermoplastic resin composition may include additives such as colorants to enhance the aesthetics of the molded article.

### Molded Articles

In certain aspects of the disclosure, the molded articles are formed by (a) providing a thermoplastic resin composition including a base polymer resin and a mold release agent; and (b) molding the thermoplastic resin composition to form the molded article. The dielectric strength of the molded article formed is higher than a comparator molded article comprising the thermoplastic resin composition in the absence of the mold release agent.

In one aspect, the molded article is formed using a melt forming process. In a further aspect, the melt forming process may include injection molding, blow molding, sheet and film extrusion, profile extrusion, thermoforming, additive manufacturing, compression molding, fiber extrusion, and powder sintering. In another aspect, the molded article is formed using a combination of melt forming processes e.g., injection molding followed by thermoforming.

In certain aspects of the present disclosure, the molded articles may be a variety of structural and non-structural articles, including but not limited to, wire coatings, potting materials, junctions, or other applications where it may be desirable to use an article having high dielectric strength. In a further aspect of the disclosure, the molded articles of the present disclosure may be used for distributor caps, battery casing, electrical wire insulation, wet-dry applications, self-lubricating parts, physical-shock endurance parts, appliances, e.g., pot handles, knobs and appliance bases; and electrical/electronic enclosures, such as connectors, wiring devices, circuit breakers, junction boxes, watt-hour meter bases, etc. The molded articles of the present disclosure are not limited to these applications. Other suitable applications are also contemplated.

The following examples will serve to further illustrate the invention, but it should be understood that the invention is not restricted to these specific examples. Parts and percentages are by weight unless otherwise stated.

### EXAMPLES

Two thermoplastic resin compositions were prepared according to the procedures described above. Example 1 is a thermoplastic resin composition that does not include a mold release agent. Example 2 is a thermoplastic resin composition that includes HDPE as a mold release agent. Both Examples 1 and 2 use a polyetherimide sold under the tradename ULTEM® as the base polymer resin.

### Example 1

A composition is prepared using ULTEM® 1000 (number average molecular weight (Mn) 21,000; weight average molecular weight (Mw) 54,000; dispersity 2.5) and a heat stabilizer. There is no mold release agent used in Example 1.

### Example 2

A composition is prepared using 99.7 weight % ULTEM® 1010 (number average molecular weight (Mn) 19,000; weight average molecular weight (Mw) 47,000; dispersity 2.5), 0.3 weight % HDPE as a mold release agent, 0.3 weight % carbon black and a heat stabilizer.

Example 1 and 2 compositions and their properties are summarized in Table 1. All component amounts are expressed in percentage by weight, unless stated otherwise.

TABLE 1

| | Example 1 | Example 2 |
|---|---|---|
| Composition | | |
| PEI | 100% | 99.4% |
| Heat Stabilizer | 200 ppm | 200 ppm |
| HDPE | 0 | 0.3% |
| Carbon Black | 0 | 0.3% |
| Properties | | |
| Melt Flow Rate | 7-11 g/10 min | 16-20 g/10 min |

Samples from each of Examples 1 and 2 were injection molded at a mold temperature of 300 OF (150° C.) and melt temperatures of 680-700 OF (360-370° C.), with a total cycle time of around 30-40 seconds. The samples were injection-molded into disks 3.2 mm (125 mil) thick. Dielectric strengths for the resulting molded disks were measured according to ASTM D149. Type 2 1-inch electrodes in oil were used with a rate rise of 500 Volts per second. The breakdown voltages were also calculated. The results for the molded disks formed using the composition from Example 1 are summarized in Table 2. The results for the molded disks formed using the composition from Example 2 is summarized in Table 3.

TABLE 2

| | | Breakdown | | Dielectric |
|---|---|---|---|---|
| | | Voltage | Thickness | Strength |
| Conditioning | Specimen # | (V) | (Mil) | (V/mil) |
| Minimum 48 | 1 | 48,400 | 133 | 364 |
| hours at 23° C. | 2 | 47,800 | 133 | 359 |
| 50% R.H. | 3 | 52,500 | 133 | 394 |
| | 4 | 51,100 | 132 | 388 |
| | 5 | 52,200 | 134 | 390 |

| | | |
|---|---|---|
| Average: | 50,400 | 379 |

TABLE 3

| | | Breakdown | | Dielectric |
|---|---|---|---|---|
| | | Voltage | Thickness | Strength |
| Conditioning | Specimen # | (V) | (Mil) | (V/mil) |
| Minimum 48 | 6 | 69,100 | 131 | 528 |
| hours at 23° C. | 7 | 74,900 | 128 | 587 |
| 50% R.H. | 8 | 73,400 | 129 | 571 |
| | 9 | 60,400 | 128 | 472 |
| | 10 | 74,300 | 129 | 578 |

| | | |
|---|---|---|
| Average: | 70,420 | 547 |

The results in Tables 2 and 3 show significantly higher dielectric strengths and breakdown voltages are achieved for molded disks formed using the mold release agent compared to the molded disks that are formed without using any mold release agent. As shown in Table 2, the molded disks formed using the Example 1 composition (specimens 1-5) had an average dielectric strength of 379 V/mil and an average breakdown voltage of 50,400 V. As shown in Table 3, the molded disks formed using the Example 2 composition (specimens 6-10) had an average breakdown voltage of 547 V/mil and an average dielectric strength of 70,420 V.

The surface of each of the sample molded disks previously formed were machined to reduce the overall thickness of the disk from 125 mils to 75 mils. After machining, the dielectric strengths for the molded disks were then measured again according to ASTM D149. Type 2 1-inch electrodes in oil were used with a rate rise of 500 Volts per second. The dielectric strengths for the machined disks were the compared with the molded disks. The results for the machined disks formed using the composition from Example 1 are summarized in Table 4. The results for the machined disks formed using the composition from Example 2 is summarized in Table 5.

TABLE 4

| | | Breakdown | | Dielectric |
|---|---|---|---|---|
| | | Voltage | Thickness | Strength |
| Conditioning | Specimen # | (V) | (Mil) | (V/mil) |
| Minimum 48 | 11 | 38,700 | 75 | 516 |
| hours at 23° C. | 12 | 40,800 | 75 | 544 |
| 50% R.H. | 13 | 35,900 | 75 | 479 |
| | 14 | 41,900 | 75 | 559 |
| | 15 | 43,300 | 75 | 577 |

| | | |
|---|---|---|
| Average: | 40,120 | 535 |

TABLE 5

| | | Breakdown | | Dielectric |
|---|---|---|---|---|
| | | Voltage | Thickness | Strength |
| Conditioning | Specimen # | (V) | (Mil) | (V/mil) |
| Minimum 48 | 16 | 42,600 | 75 | 568 |
| hours at 23° C. | 17 | 47,900 | 75 | 639 |
| 50% R.H. | 18 | 46,400 | 75 | 619 |
| | 19 | 42,200 | 75 | 563 |
| | 20 | 42,700 | 75 | 569 |

| | | |
|---|---|---|
| Average: | 44,360 | 591 |

The results in Tables 4 and 5 continue to show higher dielectric strengths and breakdown voltages for the machined disks formed using the mold release agent as compared to the machined disks that are formed without using mold release agent. As shown in Table 4, the machined disks formed without HDPE (specimens 11-15) had an average dielectric strength of 535 V/mil and an average breakdown voltage of 40,120 V. As shown in Table 5, the machined disks formed using HDPE (specimens 16-20) had an average breakdown voltage of 591 V/mil and an average dielectric strength of 44,360 V.

The results in Tables 4 and 5 further show that the difference in the dielectric strengths and breakdown voltages is not as significantly increased for the machined disks (specimens 16-20) as it was for the molded disks that were not machined (specimens 6-10). The machining process adversely affects the improvement in dielectric strength and breakdown voltage observed in the molded part. For molded disks (specimens 1-10), the average dielectric strength increased from 379 V/mil (Specimens 1-5) to 547 V/mil (specimens 6-10). For machined disks (specimens 11-20), the average dielectric strength increased from 535 V/mil (specimens 11-15) to 591 V/mil (specimens 16-20).

The results further show that incorporating the mold release agent into the thermoplastic resin composition used to form the molded disks is responsible for the significant increase in dielectric strength and breakdown voltage. The mold release agent during the molding process migrates to the surface of the molded disk. Machining the surface of the molded disk at least partially removes the surface that is concentrated in the mold release agent, thereby diminishing the benefit observed in the molded disk using the mold release agent.

### Aspects

In various aspects, the present disclosure pertains to and includes at least the following aspects: Aspect 1: A process for the production of a molded article, the process comprising: (a) providing a thermoplastic resin composition including a base polymer resin and a mold release agent; and (b) molding the thermoplastic resin composition to form the molded article, wherein the dielectric strength of the molded article is higher than a comparator molded article comprising the thermoplastic resin composition in the absence of the mold release agent.

Aspect 2: The process of aspect 1, wherein the molding includes at least one melt forming process selected from the group consisting of: injection molding, blow molding, sheet and film extrusion, profile extrusion, thermoforming, additive manufacturing, compression molding, fiber extrusion, and powder sintering.

Aspect 3: The process of aspect 2, wherein the melt forming process includes injection molding.

Aspect 4: The process of any of the preceding aspects, wherein the base polymer resin comprises at least one polymer from the group consisting of: a polycarbonate, polyetherimide, polysulfone, polyesters, polyamides, and polypropylene.

Aspect 5: The process of aspect 4, wherein the base polymer resin comprises polyetherimide.

Aspect 6: The process of any of the preceding aspects, wherein the mold release agent comprises at least one polymer from the group consisting of: silicone, polypropylene, polyphenylene ether or polyethylene.

Aspect 7: The process of aspect 6, wherein the mold release agent comprises polyethylene.

Aspect 8: The process of aspect 7, wherein the polyethylene comprises high density polyethylene or ultra high density polyethylene.

Aspect 9: The process of any of the preceding aspects, wherein the molded article is an extruded film or a wire coating.

Aspect 10: The process of any of the preceding aspects, wherein the dielectric strength of the molded article is at least 10% higher than the dielectric strength of the comparator molded article.

Aspect 11: The process of aspect 10, wherein the dielectric strength of the molded article is at least 40% higher than the dielectric strength of the comparator molded article.

Aspect 12: The process of any of the preceding aspects, wherein the molded article has a wall thickness from about 0.075 inches to about 0.125 inches.

Aspect 13: The process of any of the preceding aspects, wherein the dielectric strength of the molded article is at least 400 V/mil.

Aspect 14: The process of any of the preceding aspects, wherein the mold release agent is 0.01 wt % to 5 wt % of the thermoplastic resin composition.

Aspect 15: The process of aspect 14, wherein the mold release agent is 0.1 wt % to 0.4 wt % of the thermoplastic resin composition.

Aspect 16: The process of any of the preceding aspects, wherein the base polymer resin is at least 85 wt % of the thermoplastic resin composition.

Aspect 17: The process of any of the preceding aspects, wherein the thermoplastic resin composition further comprises a reinforcing filler.

Aspect 18: The process of any of the preceding aspects, wherein the thermoplastic resin composition further comprises carbon black.

Aspect 19: The process of any of the preceding aspects, wherein the polyetherimide has a weight average molecular weight of at least about 20,000 to about 150.00 grams per mole (g/mol).

Aspect 20: The process of any of the preceding aspects, wherein the polyetherimide has a molecular weight of at least 40,000 Daltons.

Aspect 21: The process of any of the preceding aspects, wherein the polyethylene has a weight average molecular weight from about 300,000 to 500,000.

Aspect 22: The process of any of the preceding aspects, wherein the polyethylene has a molecular weight of from about 3 million to 6 million.

Aspect 23: A molded article prepared by the process comprising: (a) providing a thermoplastic resin composition including a base polymer resin and a mold release agent; and (b) molding the thermoplastic resin composition to form the molded article, wherein the dielectric strength of the molded article is higher than a comparator molded article comprising the thermoplastic resin composition in the absence of the mold release agent.

Aspect 24: The molded article of aspect 23, wherein the molding includes at least one melt forming process selected from the group consisting of: injection molding, blow molding, sheet and film extrusion, profile extrusion, thermoforming, additive manufacturing, compression molding, fiber extrusion, and powder sintering.

Aspect 25: The molded article of aspect 24, wherein the melt forming process includes injection molding.

Aspect 26: The molded article of any of the preceding aspects, wherein the base polymer resin comprises at least one polymer from the group consisting of: a polycarbonate, polyetherimide, polysulfone, polyesters, polyamides, and polypropylene.

Aspect 27: The molded article of aspect 26, wherein the base polymer resin comprises polyetherimide.

Aspect 28: The molded article of any of the preceding aspects, wherein the mold release agent comprises at least one polymer from the group consisting of: silicone, polypropylene, polyphenylene ether or polyethylene.

Aspect 29: The molded article of aspect 28, wherein the mold release agent comprises polyethylene.

Aspect 30: The molded article of aspect 29, wherein the mold release agent comprises high density polyethylene or ultra high density polyethylene.

Aspect 31: The molded article of any of the preceding aspects, wherein the molded article is an extruded film or a wire coating.

Aspect 32: The molded article of any of the preceding aspects, wherein the dielectric strength of the molded article is at least 10% higher than the dielectric strength of the comparator molded article.

Aspect 33: The molded article of aspect 32, wherein the dielectric strength of the molded article is at least 40% higher than the dielectric strength of the comparator molded article.

Aspect 34: The molded article of any of the preceding aspects, wherein the molded article has a wall thickness from about 0.075 inches to about 0.125 inches.

Aspect 35: The molded article of any of the preceding aspects, wherein the dielectric strength of the molded article is at least 400 V/mil.

Aspect 36: The molded article of any of the preceding aspects, wherein the mold release agent is 0.01 wt % to 5 wt % of the thermoplastic resin composition.

Aspect 37: The molded article of any of the preceding aspects, wherein the mold release agent is 0.1 wt % to 0.4 wt % of the thermoplastic resin composition.

Aspect 38: The molded article of any of the preceding aspects, wherein the base polymer resin is at least 85 wt % of the thermoplastic resin composition.

Aspect 39: The molded article of any of the preceding aspects, wherein the thermoplastic resin composition further comprises a reinforcing filler.

Aspect 40: The molded article of any of the preceding aspects, wherein the thermoplastic resin composition further comprises carbon black.

Aspect 41: The molded article of any of the preceding aspects, wherein the polyetherimide has a weight average molecular weight of at least about 20,000 to about 150.00 grams per mole (g/mol).

Aspect 42: The molded article of any of the preceding aspects, wherein the polyetherimide has a molecular weight of at least 40,000 Daltons.

Aspect 43: The molded article of any of the preceding aspects, wherein the polyethylene has a weight average molecular weight from about 300,000 to 500,000.

Aspect 44: The molded article of any of the preceding aspects, wherein the polyethylene has a molecular weight of from about 3 million to 6 million.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

### Definitions

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, example methods and materials are now described.

As used in the specification and the appended claims, the singular forms “a,” “an” and “the” include plural referents unless the context clearly dictates otherwise. Thus, for example, reference to “a nanocomposite” includes mixtures of two or more nanocomposites, and the like.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

The terms “dielectric strength” and “breakdown voltage” are used interchangeably herein. As used herein, the terms “dielectric strength” or “breakdown voltage” refer to both the properties of breakdown voltage defined in units of applied electronic field strength of volts per micron and leakage current, which is the current density typically in amps per square centimeter or pico amps per square centimeter at a specified electric field strength.

The term “molded article” as used herein refers to an article formed by any type of molding process or combination of molding processes known in the art. These molding processes include, but are not limited to, various melt forming process, injection molding, blow molding (stretch, extrusion or injection), sheet and film extrusion, profile extrusion, thermoforming, additive manufacturing, compression molding, fiber extrusion, powder sintering, transfer molding, reaction injection (RIM) molding, vacuum forming, cold casting, dip molding, slush molding and press molding.

As used herein, the terms “optional” or “optionally” means that the subsequently described event or circumstance can or cannot occur, and that the description includes instances where said event or circumstance occurs and instances where it does not.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific embodiment or combination of embodiments of the methods of the invention.

References in the specification and concluding claims to parts by weight, of a particular element or component in a composition or article, denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent of a component, unless specifically stated to the contrary, is based on the total weight of the formulation or composition in which the component is included. For example if a particular element or component in a composition or article is said to have 8% weight, it is understood that this percentage is relation to a total compositional percentage of 100%.

Each of the materials disclosed herein are either commercially available and/or the methods for the production thereof are known to those of skill in the art.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

1. A process for the production of a molded article, the process comprising:
(a) providing a thermoplastic resin composition including a base polymer resin and a mold release agent; and
(b) molding the thermoplastic resin composition to form the molded article, wherein the dielectric strength of the molded article is higher than a comparator molded article comprising the thermoplastic resin composition in the absence of the mold release agent.

2. The process of claim 1, wherein the molding includes at least one melt forming process selected from the group consisting of: injection molding, blow molding, sheet and film extrusion, profile extrusion, thermoforming, additive manufacturing, compression molding, fiber extrusion, and powder sintering.

3. The process of claim 2, wherein the melt forming process includes injection molding.

4. The process of claim 1, wherein the base polymer resin comprises polyetherimide and the polyetherimide has a weight average molecular weight of at least about 20,000 to about 150,000 grams per mole (g/mol).

5. The process of claim 1, wherein the mold release agent comprises high density polyethylene.

6. The process of claim 1, wherein the dielectric strength of the molded article is at least 10% higher than the dielectric strength of the comparator molded article.

7. The process of claim 6, wherein the dielectric strength of the molded article is at least 40% higher than the dielectric strength of the comparator molded article.

8. The process of claim 1, wherein the dielectric strength of the molded article is at least 400 V/mil.

9. A molded article prepared by the process comprising:
(a) providing a thermoplastic resin composition including a base polymer resin and a mold release agent; and
(b) molding the thermoplastic resin composition to form the molded article, wherein the dielectric strength of the molded article is higher than a comparator molded article comprising the thermoplastic resin composition in the absence of the mold release agent.

10. The molded article of claim 9, wherein the base polymer resin comprises polyetherimide having a weight average molecular weight of at least about 20,000 to about 150,000 grams per mole (g/mol).

11. The molded article of claim 9, wherein the mold release agent comprises at least one polymer from the group consisting of: silicone, polypropylene, polyphenylene ether or polyethylene.

12. The molded article of claim 11, wherein the mold release agent comprises polyethylene.

13. The molded article of claim 12, wherein the polyethylene comprises high density polyethylene or ultra high density polyethylene.

14. The molded article of claim 9, wherein the dielectric strength of the molded article is at least 10% higher than the dielectric strength of the comparator molded article.

15. The molded article of claim 14, wherein the dielectric strength of the molded article is at least 40% higher than the dielectric strength of the comparator molded article.

16. The molded article of claim 9, wherein the molded article has a wall thickness from about 0.075 inches to about 0.125 inches.

17. The molded article of claim 9, wherein the dielectric strength of the molded article is at least 400 V/mil.

18. The molded article of claim 9, wherein the mold release agent is 0.01 wt % to 5 wt % of the thermoplastic resin composition.

19. The molded article of claim 9, wherein the mold release agent is 0.1 wt % to 0.4 wt % of the thermoplastic resin composition.

20. The molded article of claim 9, wherein the base polymer resin is at least 85 wt % of the thermoplastic resin composition.
